(19) United States
(12) Patent Application Publication
(10) Pub. No.: US 2012/0240691 A1
(43) Pub. Date: Sep. 27, 2012

(54) ELASTOMERIC OPTICAL TACTILE SENSOR

(75) Inventors: NICHOLAS B. WETTELS, LOS ANGELES, CA (US); SUSAN M. SCHOBER, Huntington Beach, CA (US)

(73) Assignee: UNIVERSITY OF SOUTHERN CALIFORNIA, Los Angeles, CA (US)

(21) Appl. No.: 13/427,182

(22) Filed: Mar. 22, 2012

Related U.S. Application Data
(60) Provisional application No. 61/466,839, filed on Mar. 23, 2011.

(51) Int. Cl. G01L 1/24

(52) U.S. Cl. 73/862.624

(57) ABSTRACT

A tactile sensor may include at least one light source and multiple light sensors within a common, protective housing. Each light sensor may be oriented to detect light originating from the light source. The housing may include flexible material that deforms in response to force applied to an external surface of the housing. In turn, this may cause changes in the intensity of light that is detected by the light sensors. A signal processing system may generate information that is representative of the magnitude of the applied force in at least two orthogonal directions based on the intensity of light detected by the light sensors. Each light sensor may be contained within a cavity in the housing. The cavity may be configured such that its geometry affects the sensitivity of the light sensor to the applied force.

### CROSS-REFERENCE TO RELATED APPLICATION

This application is based upon and claims priority to U.S. provisional patent application 61/466,839, entitled “Elastomeric Optical Tactile Sensor,” filed Mar. 23, 2011, attorney docket number 028080-0642. The entire content of this application is incorporated herein by reference.

### BACKGROUND

1. Technical Field

This disclosure relates to tactile sensors.

2. Description of Related Art

Object grasping by a robotic hand or an appendage to a human hand in unstructured environments may require a sensor that is durable, compliant, and responsive to static and dynamic force conditions.

Several attempts have been made to use camera based or electro-optic modalities in tactile sensing. The camera based approaches generally involve tracking patterns or positioning landmarks on an inner surface of an elastomer. Other approaches involve modulating a signal between a light emitting element and a light sensor or coupling optical waveguides. However, these may present integration, computational performance, and/or cost issues.

Numerous transduction methods have also been implemented, such as optics, capacitance, piezoresistance, ultrasound, and conductive polymers. However, their effectiveness may be limited to specific environments or specific applications. For example, most MEMS sensors may provide good resolution and sensitivity, but may lack the robustness needed for many applications outside of the laboratory.

A solution to these problems continues to be needed.

### SUMMARY

A tactile sensor may include at least one light source and multiple light sensors within a common, protective housing. Each light sensor may be oriented to detect light originating from the light source. The housing may include flexible material that flexes and/or compresses in response to force applied to an external surface of the housing. In turn, this may cause changes in the intensity of light that is detected by the light sensors. A signal processing system may generate information that is representative of the magnitude of the applied force in at least two orthogonal directions based on the intensity of light detected by the light sensors. Each light sensor may be contained within a cavity in the housing. The cavity may be configured such that its geometry, such as its width, affects the sensitivity of the light sensor to the applied force.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates a cut-away view of an example of a multi-modal tactile sensor that includes an elastomeric tactile sensor.

FIG. 2 illustrates a cross section of a portion of the elastomeric optical tactile sensor illustrated in FIG. 1.

FIGS. 3A and 3B illustrate examples of how the geometry of a the cavity in the elastomeric optical tactile sensor illustrated in FIG. 1 can affect the sensitivity of the sensor.

FIGS. 4A and 4B collectively illustrate how an elastomeric optical tactile sensor having a core, inner material, outer material, and multiple light sensors can detect both normal and tangential forces.

FIG. 5 illustrates an example of a circuit that may be used in conjunction with the elastomeric optical tactile sensor illustrated in FIG. 1 to drive an LED light source and to generate output signals from phototransistors.

FIG. 6 illustrates an example of a mold that may be used to create the core of an elastomeric optical tactile sensor.

FIG. 7 illustrates an example of a core of an elastomeric optical tactile sensor that may be created using the mold illustrated in FIG. 6.

FIG. 8 illustrates an example of a completed elastomeric optical tactile sensor attached to a fingernail-like backing.

FIG. 9 illustrates an example of an elastomeric optical tactile sensor affixed to a testing apparatus.

FIG. 10 is a graph of results of a normal force being applied repeatedly to an example of an elastomeric optical tactile sensor.

FIG. 11 are graphs that compare actual normal and tangential forces that were applied to an example of elastomeric optical tactile sensor and the force that was detected by the sensor.

FIG. 12 illustrates a spectogram (FFT) capturing the second harmonic of a tuning fork. The top row is light sensor output; the bottom row is force plate output.

FIG. 13 illustrates an example of a circuit that may be used to process signals from the multimode elastomeric optical tactile sensor illustrated in FIG. 1.

FIG. 14 illustrates an example of components that may be embedded in a core of an elastomeric optical tactile sensor.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

A tactile sensor may have one or more of the following properties: tri-axial force sensing (two shear plus a normal component), dynamic event sensing across slip frequencies, compliant surface for grip, wide dynamic range (depending on application), insensitivity to environmental conditions, ability to withstand abuse, good sensing behavior (e.g. low hysteresis, high repeatability), and slip and incipient slip detection. The device may also be based on elastomers and optics.

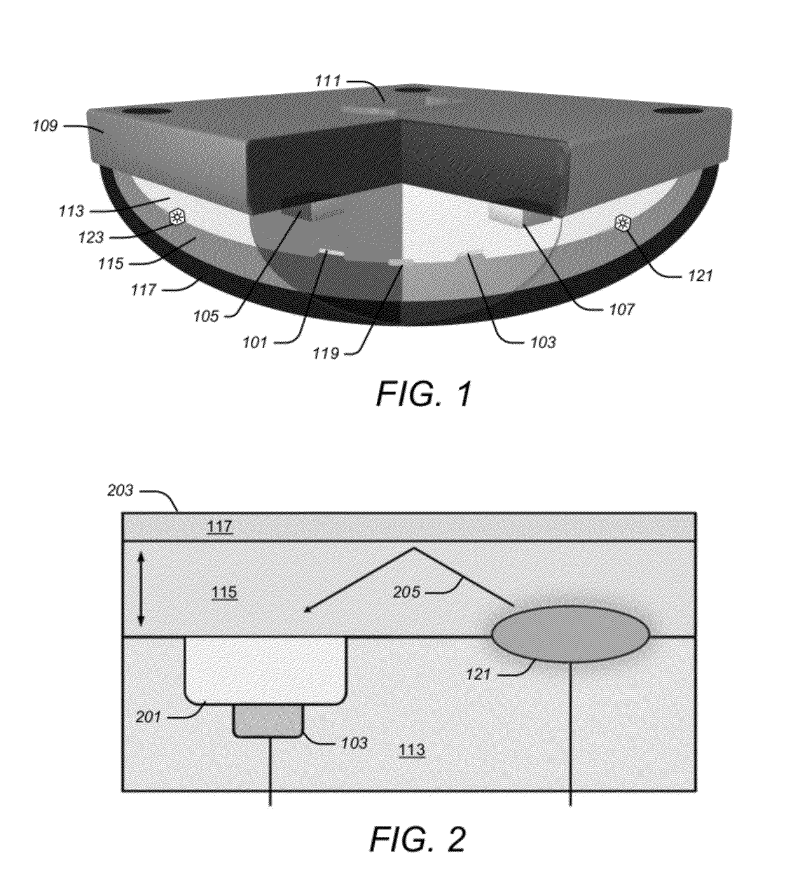

FIG. 1 illustrates a cut-away view of an example of a multi-modal tactile sensor that includes an elastomeric tactile sensor. As illustrated in FIG. 1, the multi-modal tactile sensor may incorporate multiple sensors. These may include, for example, light sources 121 and 123, light sensors 101 and 103; and consolidated sensors 105 and 107 that each may include other sensing elements (e.g. thermistors). 119. The housing for these components may include a plate 109 that may be rigid and/or opaque; a connector 111, such as a mini USB connector, mounted within the plate 109 for connecting signals from the tactile sensor to a computer or other device; a core 113; inner material 115; and outer material 117 that may provide an exterior surface that functions as a “skin” to which a force may be applied.

Each of the light sources 121 and 123 may be of any type. For example, they may be LEDs, incandescent sources, opto-isolators or other sources of light external to the sensor that may be routed in through fiber optic cable. These devices may emit visible light and/or may emit light in higher and/or lower electromagnetic bands.

Each of the light sensors 101 and 103 may be of any type. For example, they may be phototransistors, photosensors, photoresistors, and/or photodiodes.

The core 113 may be durable, rigid, and/or opaque. For example, the core 113 may be a flexible or hard rubber, an acrylic, molded plastic, cast epoxy, machined metal, or a combination of different material. The core may house and secure the various sensors and light sources in the device and maintain the relative positioning between them. As discussed in more detail below, the core may also provide a cavity for each light sensor that can be configured to control the sensitivity of the device to applied force.

The inner material 115 may be flexible, soft, deformable, compressible, and/or translucent. For example, the inner material may be an elastomeric material, an optical mesh, a fluid (gas or liquid); or anything else that attenuates light intensity through its mean free path and is deformable. The inner material 115 may abut the outer material 117, as illustrated in FIG. 1.

The outer material 117 may be durable, opaque, flexible, deformable, and/or compressible. For example, the outer material 117 may be an elastomeric material, a metal foil, an elastomer doped with metal flakes or anything else that is flexible and) causes inner and outer light to reflect, refract, and/or attenuate. For example, the outer material 117 may be opaque and internally reflective. The outer material 117 may be configured to be easily replaced in the invent of damage or contamination during use. The outer material 117 may also function to keep out ambient light.

The tactile sensor may have any dimensions, such as about 1″×1″×0.5″. The dimensions may be determined by the emitter and sensor size and arrangement.

In a different embodiment, a single piece of homogeneous material may serve as both the inner material 115 and the outer material 117.

In a still different embodiment, one or more of the internal sensors may be omitted.

The light from one or more of the light sources 121 and 123 may be configured to travel through the inner material 115 to one or more of the light sensors 101 and 103. On the way, the light may be partially absorbed and/or scattered by the inner material 115, thus causing attenuation of the light as it travels to the light sensors 101 and 103. The light may also reflect one or more times off of the inner surface of the outer material 117 and/or the inner surface of the inner material 115, thus increasing the length of the pathway and, in turn, the amount of attenuation. One or more of the surfaces off of which the light reflects may also be diffuse, resulting in omni-directional reflection due to the surface irregularities in the materials, thus causing further attenuation of the light intensity as a result of each reflection.

Features about an object that contacts the external surface of the outer material 117, such as center of pressure and force vectors, may be extracted from the outputs of the sensors, such as the outputs of the light sensors 101 and 103. The voltage versus force relationship provided by this molded device may have a wide dynamic range that coincides with forces relevant for most human grip tasks.

FIG. 2 illustrates a cross section of a portion of the elastomeric optical tactile sensor illustrated in FIG. 1. Each light sensor, such as the light sensor 103 may be embedded in a cavity 201 within the core 113. The cavity 201 may be filed with a clear gas, such as air; a clear liquid, such as water; or may be a vacuum. Light may be further attenuated as it travels through the cavity 201.

As illustrated in FIG. 2, light 205 may be emitted from the light source 121 and may reflect off of a diffuse interior surface of the outer material 117 and then be received by the light sensor 103. Application of force to an exterior surface 203 of the outer material 117 may cause the outer material 117 to flex and/or compress. In turn, this may cause the inner material 115 to flex and/or compress. In turn, this may shorten the pathway for the light 205 that travels from the light source 121 to the light sensor 103. In turn, this may cause an increase in the intensity of the light when received by the light sensor 103, thus providing an output from the light sensor 103 that is indicative of the force that is applied to the exterior surface 203.

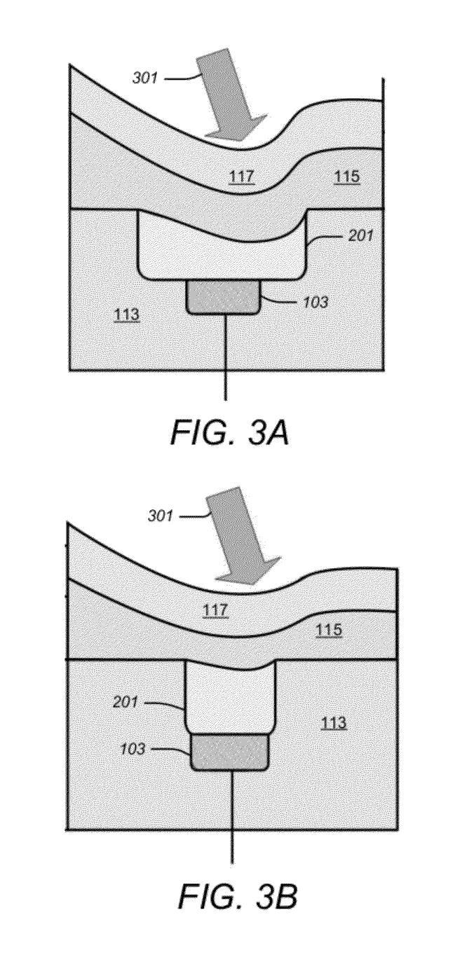

FIGS. 3A and 3B illustrate examples of how the geometry of the cavity 201 in the elastomeric optical tactile sensor illustrated in FIG. 1 can affect the sensitivity of the sensor. As illustrated in FIG. 3, a force 301 may be applied to the outer material 117. This may in turn squeeze the inner material 115, thus reducing the horizontal travel of the light generated by the light source (not shown in FIGS. 3A and 3B). When the cavity is narrower, as illustrated in FIG. 3B, a greater portion of the light may be blocked from the light sensor 103, thus providing greater sensitivity to changes in the applied force. Still further enhancements in sensitivity may be realized by a cavity that is even narrower than is illustrated in FIG. 3B. Conversely, reductions in sensitivity may be realized by a cavity that is wider than is illustrated in FIG. 3A.

As light travels to a light sensor, it may be affected by absorption. When the core 113 and the outer material 117 are largely reflective, a translucent inner material 115 may create a weakly absorbing system. Specifically, there may be an attenuation of:

I=I₀e^{-γx}

where Io is the intensity of the light passing through a medium; a is the absorption coefficient of the material (wave length dependent) and equal to −kₒ/n_{X}″, where kₒ is the wave number and n is the index of refraction; x is the distance the light must travel through a given material; and X″ is the imaginary component of susceptibility and X′ is the real component.

X″<<X′+1

When no force is applied, the light may take a given path to reach the light sensor 103 and may undergo one interaction with the core 113 and one with the outer material 117. Application of a force may cause the path to be altered causing two interactions with the core 113 and the outer material 117. Although this is a contrived illustration, it demonstrates how these materials and the surfaces that they present may interact with the light path. Although a small amount of light may be absorbed and converted to heat, the primary effect of the translucent elastomer on the light path may be scattering. Several types of scattering may occur in non-crystalline solids, including Raleigh scattering, represented by elastic collisions and Raman scattering, resulting in inelastic collisions. As the soft inner material 115 deforms; the amount of material the light is required to travel through to the light sensor may change, causing a change in intensity at the light sensor as well.

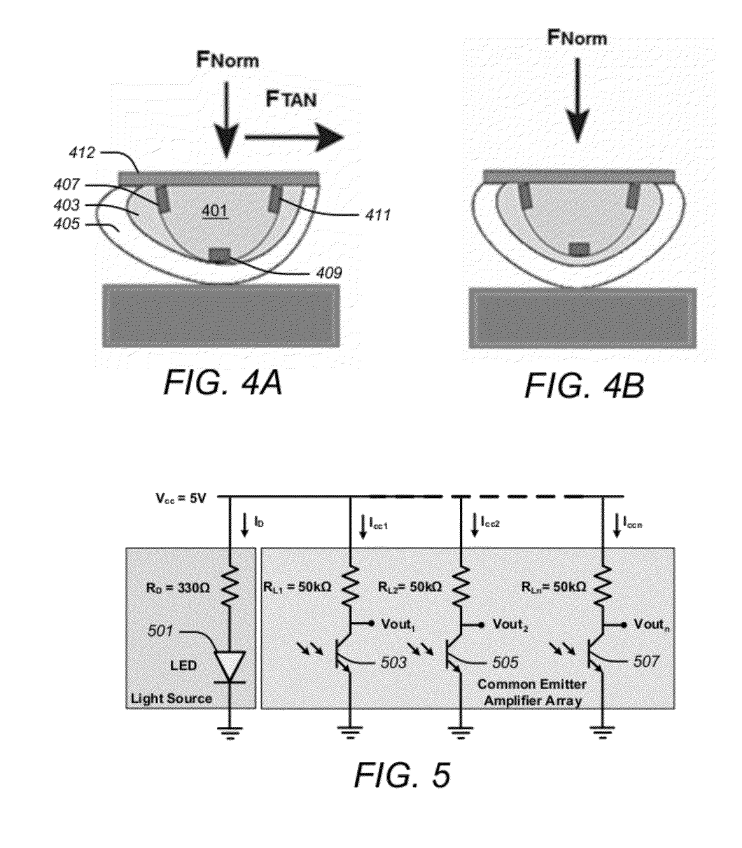

FIGS. 4A and 4B collectively illustrate how an elastomeric optical tactile sensor having a core 401, inner material 403, outer material 405, and multiple light sensors 407, 409, and 411 can detect both normal and tangential forces. The inner material 403 may be an elastomer that is translucent and very compliant, the outer material 405 may be an elastomer that is opaque and reflective, and the light sensors 407, 409, and 411 may be arranged to face all planes of action (X, Y, Z), thereby allowing force to be sensed in these dimensions. By orienting the light sensors in this fashion, normal and tangential forces may be extracted from contacted objects. Specifically, normal forces may bulge the inner material 403 outwards away from the lateral light sensors 407 and 409, while compressing the lower light sensor 409. Tangential forces may alter the symmetry between the left and right light sensors. Each of these components may have any of the characteristics discussed above in connection with the same named component, including the cavity 201 discussed above.

As also illustrated in FIGS. 4A and 4B, an anchor-like backing 412 of rigid material may be provided to prevent the rear of the device from moving in response to an applied force, thereby ensuring that the full magnitude of the force is applied to the outer and inner materials.

As discussed above, several effects may be combined to reduce the light intensity when objects contact the sensor, such as scattering, absorption, and light sensor occlusion. This may result in a monotonic, but non-linear response. This monotonic response may facilitate the use of machine learning algorithms in a data processing system to extract normal and tangential force information form the output of the light sensors. There may be cross-axis effects from forces. The sensor output for tangential forces may depend on the amount of normal force applied as the skin is depressed (and vice versa). However, the sensor may be calibrated by training a machine learning algorithm with a variety of moments, forces and objects designed to capture such effects. These sensors may be arranged in a unique pattern with respect to each 3 dimensional axis. Specifically, there may be a sensing element facing the plane of action (e.g. X, Y, Z) to detect that direction of force or torque. There may also be on and off-axis facing elements in each plane of action to resolve cross-axis sensitivity (i.e. when just an X force is applied and then a Y force is applied, the X change is measured). The processing system may include a standard data acquisition system that sends data into a microprocessor (either local or remote). This processor may then use machine learning techniques like neural networks or support vector machines to interpret the non-linear data and disambiguate the 3 forces and 3 torques based upon prior training data.

Any type of circuitry may be used to process the signals from the sensors within the device.

FIG. 5 illustrates an example of a circuit that may be used in conjunction with the elastomeric optical tactile sensor illustrated in FIG. 1 to drive an LED light source 501 (which may be the light source 121 and/or 123) and to generate output signals from phototransistors 503, 505, and 507 (e.g. silicon NPN phototransistors: Vishay Semiconductors BPW16N) (which may be the light sensors 101 and/or 103). Some or all of these components may be placed within or outside of the optical tactile sensor, such as within the core 113. As illustrated, the phototransistors 503, 505, and 507 may each function as a variable resistor when driven by a dc signal.

The common-emitter amplifier circuits illustrated in FIG. 5 may generate “n” voltage outputs that transition from a high to a low state when light in the visible range of 400 nm to 700 nm (or other electromagnetic range) is detected by each phototransistor's base. Each output voltage in the array may be produced by connecting a resistor between the voltage supply and the collector of the phototransistor. The output voltage may be read at the terminal of the collector. Since the configuration may act as an amplifier, the phototransistor may magnify this current to useful levels that can be measured. The result may be that the voltage outputs of each of the phototransistors in the array may change from higher values to lower values (and vice-versa) depending on the amount of visible light detected on their base terminal. Collector-emitter current for the transistor may depend on the incipient light as well as the collector-emitter voltage (e.g., fixed at +5 VDC).

The core 113 of the device may be formed from a wax mold that is machined by a CNC mill using a geometry generated in Inventor and MasterCam X.

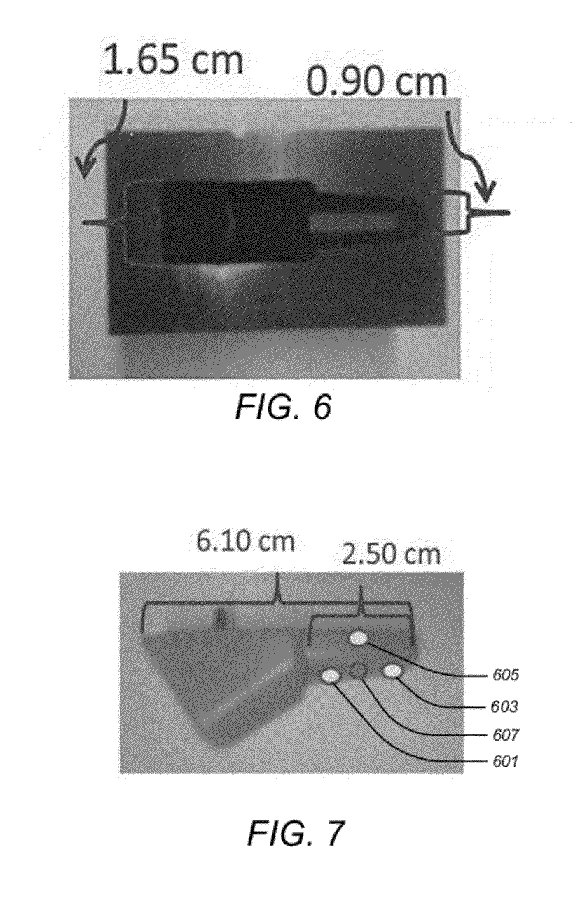

FIG. 6 illustrates an example of a mold that may be used to create the core 113 of an elastomeric optical tactile sensor.

FIG. 7 illustrates an example of a core of an elastomeric optical tactile sensor that may be created using the mold illustrated in FIG. 6. During molding, a light source 601 and light sensors 603, 605, and 607 may be embedded within the core. Each light sensor may be located, for example, about 10 mm away from the light source.

Internal circuitry may be soldered together or embedded within a printed circuit board and also placed within the core during the molding process. The light sensor may be held in place with a bonding agent. The positions of the light sensors may be predetermined and holes may be drilled to house silicone tubing plugs. These plugs may fit to the ends of the light sensors and act to create necessary recesses, as well as holding them in place during fabrication. The light sensors may be recessed, such as by about 2 mm.

Once all of the necessary components are in place, the mold may be cast, such as with a commercial dental acrylic (Hygenic Perm Reline & Repair Resin). One or more screws may be placed in the mold to act as anchor studs for the “fingernail” that may act to control the deformation of the elastomer, such that the rear of the elastomer is not loose and free to move. The finished core may be removed from the mold and coated in elastomers.

The sensor may be over-modled, dip or pour-coated with a very soft silicone elastomer, such as Ecoflex 0010 (hardness: Shore 00-10A, Smooth-On Inc). The sensor may then be heat cured, such as with a 750 F heat gun for 10 seconds before pour-coating in Silastic E (hardness: Shore A 35, Dow Corning Inc) by the same process. The precise optical characterization may be determined though scattering and refractive properties may be changeable in polymers by using the proper dopants. After complete curing, a “fingernail,” that may be made of a hard but lightweight material such as aluminum, may be installed to complete the device.

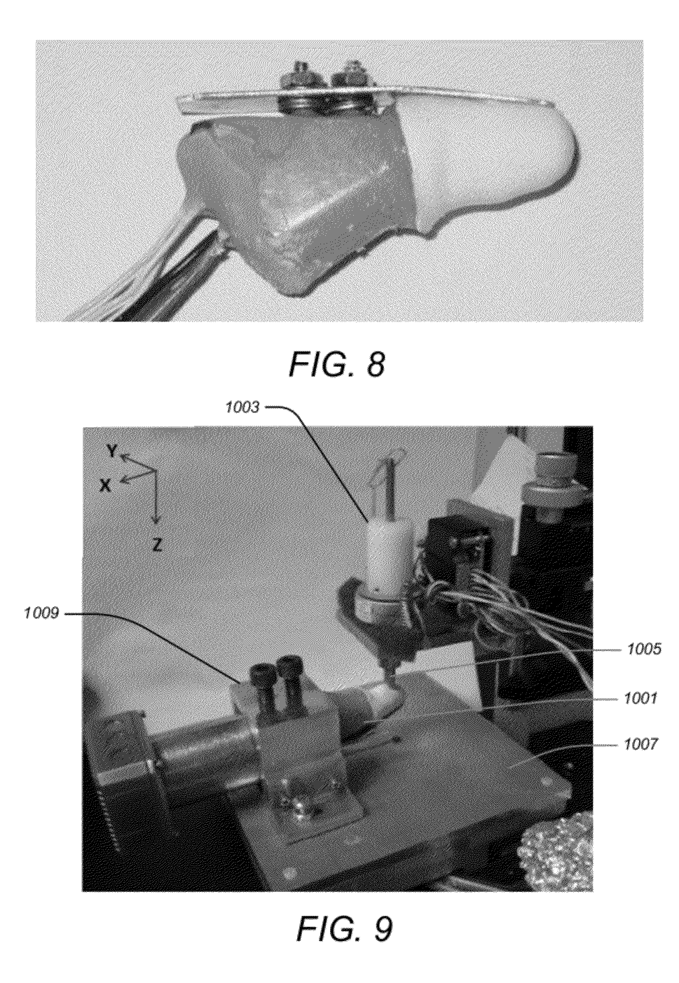

FIG. 8 illustrates an example of a completed elastomeric optical tactile sensor attached to a fingernail-like backing.

FIG. 9 illustrates an example of an elastomeric optical tactile sensor affixed to a testing apparatus. Forces were applied to the ventral, distal phototransistor of the device shown in FIG. 9 to characterize its quasi-static behavior. A linear drive 1003 (a Nippon Pulse America; PFL35T-48Q4C (120) stepper motor and NPADIOBF chopper drive) was used to advance a probe 1005 (having a diameter of about 20 mm and radius of curvature of abut 10 mm). Normal force was measured using a six-axis force-plate 1007 (Advanced Mechanical Technology; HE6×6-16) positioned below a vise 1009 holding the device. The test was repeated 10 times and an integral generated over force versus output voltage using the Trapezoidal Rule with a sample rate of 100 Hz. The error rate was calculated by comparing the integral of subsequent trials versus the first using the following equation:

$$Error - 100 \% \times \frac{\int Trial 1 - \int Trial X}{\int Trial 1}$$

Mean and Standard Deviation of Error were Generated.

The sensor was also subjected to manually applied lateral “push-pull” forces to explore the normal to tangential force response of the device (bi-axial forces only). A training set was constructed consisting of several pressing and sliding movements applied on the skin of the device while it was bolted to the vise atop the previously described 6-DOF force-plate. Spearman correlation coefficients between tangential-facing phototransistor and forces and normal phototransistor and forces were calculated.

To explore if normal and tangential force data are embedded in sensor response, a three-layer back-propagation perceptron was used. It is capable of approximating any given nonlinear relation when a sufficient number of neurons are provided in the hidden layer. MATLAB's Neural Network Toolbox 6.0.4 was used, and data for each voltage channel were preprocessed by subtracting the mean and dividing by the variance. This software employed the Levenberg-Marquardt backwards propagation algorithm to tune the weights and biases of the artificial neural network (ANN) to maximize the correlation between the model predictions and the recorded data. Hidden and output units used hyperbolic tangent and linear activation functions, respectively. Hidden layer size was chosen at 5 (greater than the number of inputs); and over-fitting was managed by using early stopping and Bayesian regularization.

Prior to ANN training, the primary data sets were divided into three sets: 1) a working set (70%), with which the ANN was trained via back-propagation; 2) a validation set consisting of 15% of randomly chosen data to prevent over fitting; and 3) a test set of 15% randomly chosen data used to measure the ANN's ability to generalize after training. Standardized mean square error (SMSE) and correlation coefficient were reported.

A primitive experiment was performed to estimate the frequency response of the sensor. A vertically oscillating flat probe (a tuning fork attuned to C3=130.8 Hz) was applied to the fingertip while recording the vertical force and output voltage of the distal sensor. Response was simultaneously recorded from the previously mentioned force plate. The frequency response of the sensor and associated electronics should be fast enough to preclude significant delays in a grasp control system relative to the speed of the actuators.

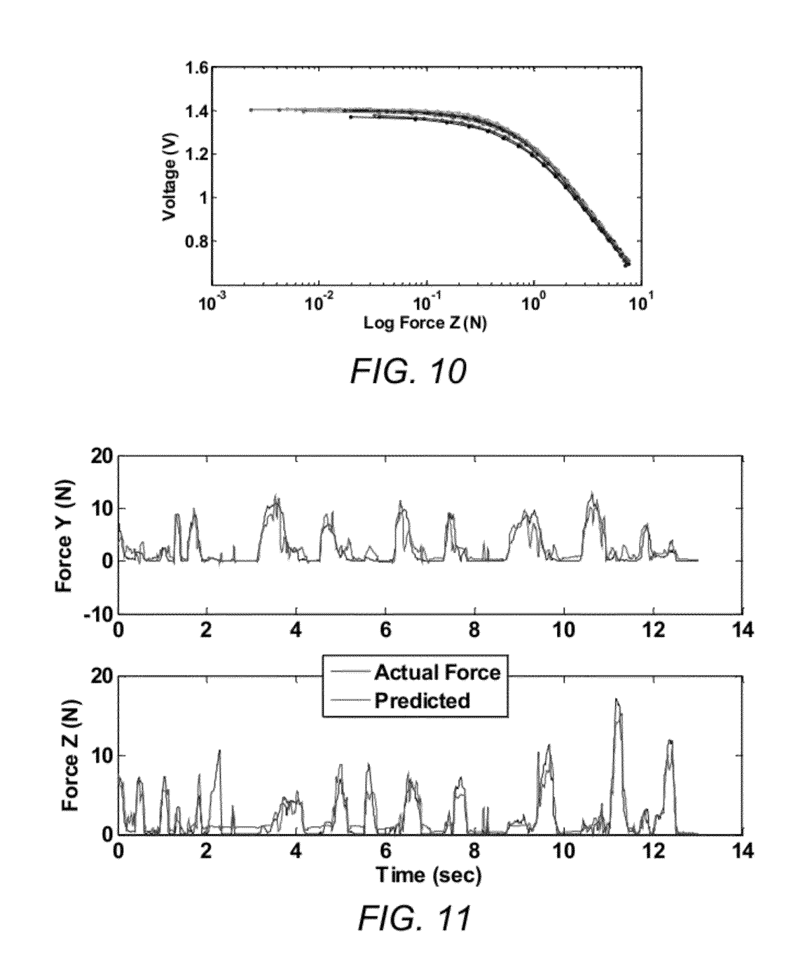

FIG. 10 is a graph of the results of the same normal force being applied repeatedly to an example of an elastomeric optical tactile sensor. The FIG. 10 demonstrates that the sensor can detect a wide dynamic range of force and appears not to saturate yet near 10N. The figure shows that the sensor was responsive over physiologically relevant grip force ranges with high repeatability observed: 2.11+1-1.35%.

A second experiment was performed to explore the sensor's ability to resolve tangential as well as normal forces. Spearman correlation for Y tangential force were 0.441 (p<0.0001) and 0.491 (p<0.0001) for Z. Each force was resolved via two separate ANNs with input from only two light sensors.

FIG. 11 are graphs that compare actual normal and tangential forces that were applied to an example of elastomeric optical tactile sensor and the force that was detected by the sensor.

The results are summarized in the following table:

| Force | SMSE | Corr. Coeff. |
|---|---|---|
| Y | 0.345 | 0.814 |
| Z | 0.416 | 0.766 |

FIG. 11 illustrates a comparison of measured Y-tangential forces (top) and Z-normal forces (bottom) to actual forces.

As the tuning fork's amplitude decreases (after 2.4 sec and shown by decreasing force plate response); the sensor showed a loss of response as stimulus amplitude decreases as well, indicating amplitude dependency.

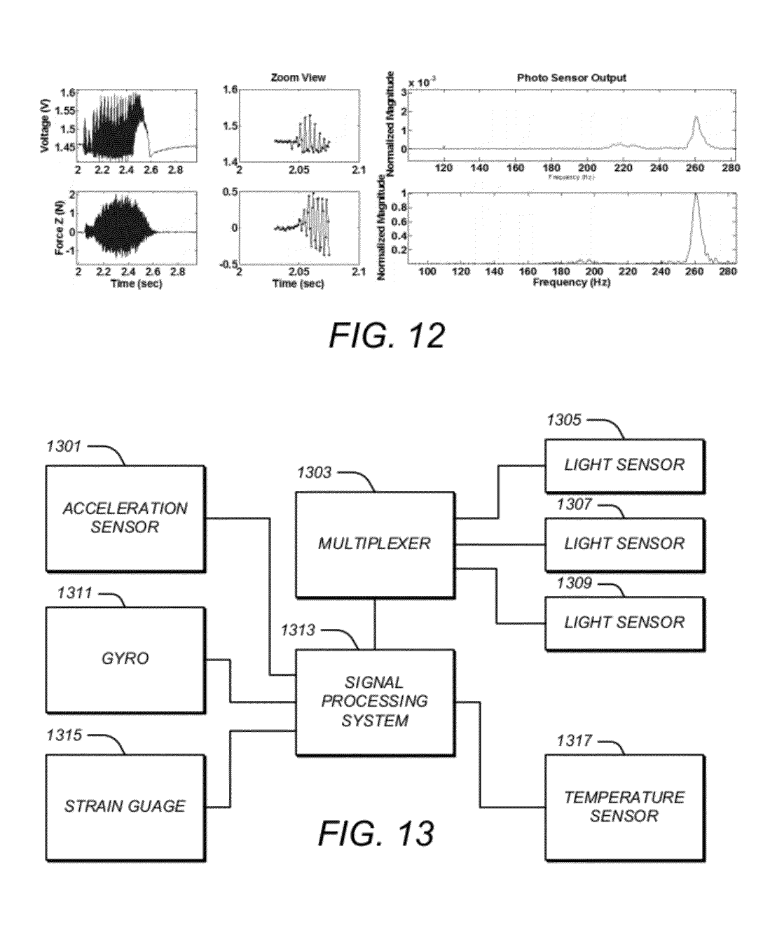

FIG. 12 illustrates a spectogram (FFT) capturing the second harmonic of the tuning fork (middle C, f=261.6 Hz). The top row is light sensor output; the bottom row is force plate output. The left column is a global view; the right column is a zoom view of onset. This figure shows that there is potential for amplitude dependent dynamic representation of stimulus. The temporal details of the mechanical input were well-represented over the range of loads tested informally.

The sensor may be sensitive to forces over a wide dynamic and physiologically relevant range with good repeatability. Sensor response may not yet saturate at the upper end of forces (upper test range limited by jig). An ANN was used to show that features like forces can be extracted from the device. The ANN only used two inputs. Other configurations may use many more sensing elements and higher tolerances of construction.

The dynamic experiment shows there is faithful reproduction of high frequency components in the elastomer, suggesting low hysteresis at these frequencies.

The device was able to extract normal and tangential forces from only two inputs using a compliant grip surface. This ability may be increased with a more robust set of light sensors. The device also showed a highly repeatable voltage-force profile over a physiologically relevant dynamic range.

FIG. 13 illustrates an example of a circuit that may be used to process signals from the multimode elastomeric optical tactile sensor illustrated in FIG. 1. As illustrated in FIG. 13, output from light sensors 1305, 1307, and 1309 may be sampled by a signal processing system 1313 using a multiplexer 1303. The signal processing system 1313 may be configured to extract two and/or three dimensional information about the force that is applied using any of the approaches discussed above.

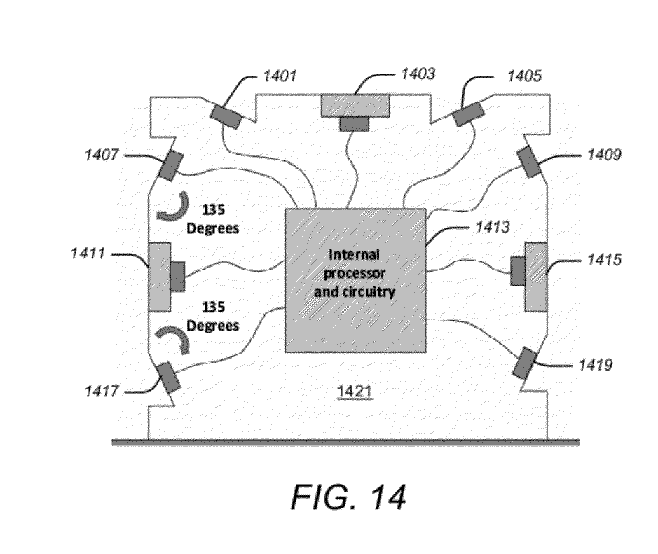

FIG. 14 illustrates an example of components that may be embedded in a core 1421 of an elastomeric optical tactile sensor. These components may include, for example, light sources 1401, 1405, 1407, 1409, 1417, and 1419; light sensors 1403, 1411, and 1415; and a signal processing system 1413. All of these components may be embedded in a core 1421. As illustrated in FIG. 14, there may be more than two light sensors facing non-coincidental directions in the same plane. These may be used to resolve cross-axis sensitivity between force measurements.

The following references provide details about various components and/or approaches that may be used in one or more of the embodiments discussed above:
Rothwell J. C., Traub, M. M., Day, B. L., Obesko, J. A, Thomas, P. K., and Marsden, C. D. “Manual Motor Performance in a Deafferenated Man,” Brain Vol. 105 pp. 515-542, (1982)
Westling G. and Johansson R. S., “Factors influencing the force control during precision grip”. Experimental Brain Research. 53(2):277-84, (1984)
Kontarinis D. A. and Howe R. D., “Tactile display of vibratory information in teleoperation and virtual environments”. Presence: Teleoperators and Virtual Environments. 4(4):387-402, (1995)
De Silva C., “Mechatronics: An Integrated Approach”. CRC Press, Boca Raton, Fla., ch. 6, (2005)
Kuchenbecker, K. J., Gewirtz, J., McMahan, W., Standish, D., Martin, P., Jonathan Bohren, J, Mendoza, P., “VerroTouch: High-frequency acceleration feedback for telerobot surgery.” Lecture Notes in Computer Science (including subseries Lecture Notes in Artificial Intelligence and Lecture Notes in Bioinformatics), (2010)
Sukhoy, V., Sahai, R., Sinapov, J., Sinapov, J., and Stoytchev, A., “Vibrotactile Recognition of Surface Textures by a Humanoid Robot” In proceedings of the 2009 Humanoids Workshop: Tactile Sensing in Humanoids: Tactile Sensors and Beyond, (2009)
Dahiya R., Metta G., Valle M., Sandini G., “Tactile Sensing—From Humans to Humanoids,” IEEE Transactions on Robotics, Vol. 26(1), pp 1-20, (2010)
Lee M. H. and Nicholls H. R., “Tactile sensing for mechatronics-A state of the art survey,” Mechatronics, vol. 9, pp. 1-31, (1999)
Melchiorri C., “Tactile Sensing for Robotic Manipulation,” Ramsete: Lecture Notes in Control and Information Sciences, vol. 270, Springer, Berlin, (2001)
Pletner, B., Kessenich, G. R., & Horth, W. U.S. Pat. No. 7,629,728. USA. (2009) Pletner, B., Kessenich, G. R., & Horth, W. U.S. Pat. No. 7,656,076. USA. (2010)
Hristu D., Ferrier N., and Brockett R. W., “The performance of a deformable-membrane tactile sensor: basic results on geometrically-defined tasks,” IEEE Internation Conference on Robotics and Automation, San Francisco, vol. 1, pp. 508-513, (2000)
Ohka M., “Optical three-axis tactile sensor”, Mobile Robots: Towards New Applications, ARS Journal and Springer, ch. 6, (2007)
Crosnier, J. “Grasping systems with tactile sense using optical fibres,” Robot Sensors, vol. 2: Tactile and Non-Vision. IFS Publications/Springer-Veriag, New York, pp 209-217, (1986)
Schneiter J. L. and Sheridan, T. B. “An optical tactile sensor for manipulators” Robotics and Computer Integrated Manufacturing. Vol 1 No. 1 pp. 65-71, (1984)
Tan D., Wang, Q., Song R., Yao X. and Gu, Y., “Optical fiber based slide tactile sensor for underwater robots” Journal of Marine Science and Application Vol. 7, No. 2, pp. 122-126 (2008)
Persichetti A., Vecchi F., and Carrozza M. C., “Optoelectronic-based flexible contact sensor for prosthetic hand application,” IEEE Conference on Rehabilitation Robotics, Netherlands, pp. 415-420, (2007)
Ferraris E., Van Gijseghem T., Yan C., Van Hoe B., Van Steenberge G, Van Daele P., Dubruel P., Reynaerts D., “Embedding of fibre optic sensors within flexible host,” Proc. Int'l Conf. Multi-Mater. Micro Manufact. (4M)/Int'l Conf. Micro Manufact. (ICOMM), pp. 351-354, (2009)
Wettels N., Santos V. J., Johansson R. S, and Loeb G. E., “Biomimetic tactile sensor array.” Advanced Robotics, vol. 22, no. 7 pp. 829-849, June (2008)
Hecht, E. Optics (4th ed.). Boston, Mass. USA Addison Wesley (2002)
Saleh B. E. A, and Teich M. C. “Fundamentals of Photonics (2nd ed.)” Wiley-Interscience, Hoboken, N.J. USA (2007)
Flygare W. H. and Gierke T. D., “Light scattering in noncrystalline solids and liquid crystals,” Annu. Rev. Mater. Sci. 4: pp. 255-285 (1974)
Wiley, R. H., Hobson P. H “Determination of Refractive Index of Polymers”, Anal. Chem., 20 (6), pp. 520-523, (1948)
SPIE Newsroom. “Tuning the polymer refractive index with nanosized organic dopants” DOI: 10.1117/2.1200810.1300 5 Nov. (2008)
Bishop C. M. “Neural Networks for Pattern Recognition,” Oxford: University Press, (1995)
Hagan M. T. and Menhaj M. “Training multilayer networks with the Marquardt algorithm,” IEEE Tran. Neural Networks 5: pp. 989-993, (1994)
Sarle, W. S. “Stopped Training and Other Remedies for Overfitting,” Proceedings of the 27th Symposium on the Interface of Computing Science and Statistics, pp. 352-360, (1995)

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

For example, the mechanical properties of the inner and outer layers may vary, so long as they are deformable or flexible (e.g. rubber, fabric, etc). The core, inner and outer layers may also have varying optical properties that cause a variety of attenuation effects on light intensity between emission and reception; such as, but not limited to: refraction, incomplete reflection, scattering and absorption. The orientation/configuration of the light sensors is not limited to right angles—the surface may be curved, planar or combination thereof. There may be at least two sensors per orthogonal facing surface oriented in different directions to: 1) sense dual or tri-axial forces, and 2) resolve cross-axis sensitivity.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases in a claim mean that the claim is not intended to and should not be interpreted to be limited to these corresponding structures, materials, or acts or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as first and second and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A tactile sensor comprising:
at least one light source;
multiple light sensors, each oriented to detect light that originates from the light source;
an external surface oriented to receive an applied force;
flexible material configured to:
flex in response to force applied to the external surface; and
cause a change in the intensity of light that travels from the light source to each of the light sensors in response to a change in the applied force;
a housing containing the light source, the light sensors, and the flexible material, the external surface being on the exterior of the housing; and
a signal processing system having a configuration that generates information that is representative of the magnitude of the applied force in at least two orthogonal directions based on the light detected by the light sensors.

2. The tactile sensor of claim 1 further comprising a cavity within the housing that contains the light sensors and that has an opening through which light from the light source can travel to the light sensors, wherein the cavity and the flexible material have a configuration and orientation that causes the sensitivity of the light sensors to changes in the applied force to be a function of the geometry of the cavity.

3. The tactile sensor of claim 2 wherein the cavity is filled with a clear gas.

4. The tactile sensor of claim 2 wherein the cavity is filled with a clear liquid.

5. The tactile sensor of claim 2 wherein the cavity is formed within material that is substantially inflexible.

6. The tactile sensor of claim 2 wherein the cavity is formed in material that is substantially opaque.

7. The tactile sensor of claim 1 wherein the flexible material comprises a layer of substantially opaque flexible material and a layer of substantially translucent, flexible material abutting the substantially opaque flexible material.

8. The tactile sensor of claim 7 wherein the external surface is a surface on the substantially opaque flexible material.

9. The tactile sensor of claim 1 wherein the flexible material includes deformable material that deforms in response to the applied force.

10. The tactile sensor of claim 1 wherein the signal processing system has a configuration that generates information that is representative of the magnitude of the applied force in three orthogonal directions based on the light detected by the light sensors.

11. The tactile sensor of claim 1 wherein the multiple light sensors include two light sensors substantially facing one another and a third light sensor substantially facing a direction that is orthogonal to the facing directions of the two light sensors.

12. A tactile sensor comprising:
at least one light source;
at least one light sensor oriented to detect light that originates from the light source;
an external surface configured to receive an applied force;
flexible material configured to:
flex in response to force applied to the external surface; and
cause a change in the intensity of light that travels from the source to the light sensor in response to a change in the applied force;
a housing containing the light source, the light sensor, and the flexible material, the external surface being on the exterior of the housing; and
a cavity within the housing that contains the light sensor and that has an opening through which light from the light source can travel to the light sensor,
wherein the cavity and the flexible material have a configuration and orientation that causes the sensitivity of the light sensor to changes in the applied force to be a function of the geometry of the cavity.

13. The tactile sensor of claim 12 wherein the cavity is filled with a clear gas.

14. The tactile sensor of claim 12 wherein the cavity is filled with a clear liquid.

15. The tactile sensor of claim 12 wherein the cavity is formed within material that is substantially inflexible.

16. The tactile sensor of claim 12 wherein the cavity is formed in material that is substantially opaque.

17. The tactile sensor of claim 12 wherein the flexible material comprises a layer of substantially opaque flexible material and a layer of substantially translucent, flexible material abutting the substantially opaque flexible material.

18. The tactile sensor of claim 17 wherein the external surface is a surface on the substantially opaque flexible material.

19. The tactile sensor of claim 17 wherein the flexible material include defomable material that deforms in response to the applied force.

20. A tactile sensor comprising:
at least one light source;
at least one light sensor oriented to detect light that originates from the light source;
substantially opaque, flexible material having an external surface that is oriented to receive an applied force and to flex in response;
substantially translucent, flexible material abutting the substantially opaque, flexible material that has a configuration that:
flexes in response to flexing of the substantially opaque, flexible material; and
causes a change in the intensity of light that travels from the light source to the light sensor in response to flexing of the substantially translucent, flexible material; and
a housing containing the light source, the light sensor, and the flexible materials, the external surface being on the exterior of the housing.
